(19) United States
(12) Patent Application Publication
(10) Pub. No.: US 2022/0151270 A1
(43) Pub. Date: May 19, 2022

(54) FRIED PRODUCTS CONTAINING A LARGE AMOUNT OF VEGETABLES

(71) Applicant: SUGIYO CO., LTD., Ishikawa (JP)

(72) Inventors: Minoru NODA, Ishikawa (JP); Kazuki TOMIYAMA, Ishikawa (JP); Hiroaki SHIMA, Ishikawa (JP); Tsubasa KOGANEI, Ishikawa (JP); Hiroya SUGINO, Ishikawa (JP); Tetsuya SUGINO, Ishikawa (JP)

(21) Appl. No.: 17/527,786

(22) Filed: Nov. 16, 2021

(30) Foreign Application Priority Data
Nov. 17, 2020 (JP) 2020-191080

(51) Int. Cl. A23L 17/00; A23L 7/157; A23P 20/12

(52) U.S. Cl. CPC A23L 17/75; A23P 20/12; A23L 7/157

(57) ABSTRACT

A problem to be solved by the present invention is to produce Satsuma-age, namely deep-fried minced fish and vegetables, and batter liquid, rich in vegetables. The above problem has been solved by the present invention by substituting vegetables for all, most, or part of the water used in the production of the Satsuma-age as well as the batter liquid. The Satsuma-age provided by the present invention and fried food produced with the batter liquid provided by the present invention are excellent because they are rich in vegetable-derived nutrients. The Satsuma-age and the fried food produced are also excellent in flavor, taste, and mouth feel.

This nonprovisional application claims priority under 35 U.S.C. § 119(a) to Patent Application No. 2020-191080 filed in Japan on Nov. 17, 2020, the entire contents of which are hereby incorporated by reference.

### TECHNICAL FIELD

The present invention relates to fried products containing a large amount of vegetables and methods for producing same. For example, the present invention relates to Satsuma-age products containing a large amount of vegetables, namely the products of deep-fried minced fish and vegetables, and methods for producing same. The present invention also relates to batter liquid containing vegetables.

### BACKGROUND ART

In methods for producing Satsuma-age, in general, fish meat or paste is used as a raw material, seasonings such as salt are added thereto, and the mashed product is molded and cooked in oil to obtain the Satsuma-age product. Satsuma-age with vegetable ingredients is made by mixing mashed fish meat or paste with vegetables cut into a certain shape, followed by molding and cooking with oil.

In recent years, attention has been paid to the functional ingredients contained in vegetables, and it is desired to develop delicious products using as many vegetables as possible; however, taking all of the ease of processing, mouth feel, and deliciousness, into consideration, the ratio of vegetables used could not exceed 50% by conventional methods. For example, Patent Document 1 states, “as for the ratio of fish paste and ingredients, more fish paste is mixed to improve moldability. For example, molding becomes easier as the ratio of fish paste increases, and machine-molding has been easily performed up to the ratio of 5:5 ingredients to fish paste. If the proportion of ingredients is larger than this, it becomes difficult to mold. Among them, vegetables are especially difficult to mold”, and as such, Patent Document 1 states that it is difficult to increase the vegetable content by 50% or more.

### PRIOR ART DOCUMENTS

### [Patent Document]

Patent Document 1: Japanese Laid-Open Publication No. 09-224613

### SUMMARY OF THE INVENTION

### Technical Problem

An objective to be achieved by the present invention is related to fried products such as Satsuma-age and is to provide such products with increased vegetable content. The present invention also provides batter liquid containing vegetables.

### Solution to Problem

In order to achieve the above objectives, the present invention provides, for example, the following means:

### (Item 1)

A fish meat paste product comprising 50% by weight or more of a vegetable.

### (Item 2)

Satsuma-age comprising a vegetable, wherein the amount of the vegetable in the Satsuma-age is 50% by weight or more.

### (Item 3)

The Satsuma-age of Item 2, wherein the amount of the vegetable in the Satsuma-age is 60% by weight or more.

### (Item 4)

The Satsuma-age of Item 2, wherein the amount of the vegetable in the Satsuma-age is 60 to 80% by weight.

### (Item 5)

The Satsuma-age of any one of Items 2-4, wherein the vegetable is a cut-processed vegetable or a mashed vegetable and wherein the vegetable is selected from the group consisting of a vegetable mixture, a bean sprout, a Japanese radish, an onion and a combination thereof.

### (Item 6)

A producing method of Satsuma-age, the method comprising:

(a) a step of providing a mixture that includes fish meat paste, salt, seasoning, starch and a vegetable, wherein the amount of the vegetable in the mixture is 50% by weight or more;

(b) a step of molding the mixture in the step (a) into a certain shape; and

(c) a step of cooking the mixture molded in the step (b) with oil.

### (Item 7)

The producing method of Item 6, wherein no water is added to the mixture in the step (a).

### (Item 8)

The producing method of Item 6, wherein the amount of the vegetable in the mixture of the step (a) is 60% by weight or more.

### (Item 9)

The producing method of Item 6, wherein the amount of the vegetable in the mixture of the step (a) is 60 to 80% by weight.

### (Item 10)

The producing method of any one of Items 6-9, wherein the vegetable is a cut-processed vegetable or a mashed vegetable and wherein the vegetable is selected from the group consisting of a vegetable mixture, a bean sprout, a Japanese radish, an onion and a combination thereof.

### (Item 11)

Satsuma-age produced by the producing method of any one of Items 6-10.

### (Item 12)

Batter liquid comprising soft flour, a vegetable and egg, wherein the content of the vegetable is 50% by weight or more.

### (Item 13)

The batter liquid of Item 12 which comprises no water.

### (Item 14)

The batter liquid of Item 12 which consists of soft flour, a vegetable and egg.

### (Item 15)

A producing method of batter liquid, the method comprising a step of preparing a mixture that includes soft flour, a vegetable and egg, characterized in that no water is added to the mixture.

### (Item 16)

A fried product made with the batter liquid of any one of Items 12-14 or the batter liquid produced by the producing method of Item 15.

### Advantageous Effect of Invention

With regard to fried products such as Satsuma-age, the present invention allows providing of such products with increased vegetable content. The present invention also provides batter liquid containing vegetables. The food products provided by the present invention are rich in vegetable-derived nutrients and is excellent in flavor, taste, and mouth feel.

### DESCRIPTION OF THE PREFERRED EMBODIMENTS

Hereinafter, the present invention will be described. Throughout the entire present specification, a singular expression should be understood as encompassing the concept thereof in the plural form, unless specifically noted otherwise. Further, the terms used herein should be understood as being used in the meaning that is commonly used in the art, unless specifically noted otherwise. Thus, unless defined otherwise, all terminologies and scientific technical terms that are used herein have the same meaning as the general understanding of those skilled in the art to which the present invention pertains. In case of a contradiction, the present specification (including the definitions) takes precedence. As used herein, “wt %” is interchangeably used with “% by weight” or “mass percentage concentration”. “%” refers to “wt %”, “w/w %”, or “mass percent concentration” unless specifically noted otherwise.

The present invention provides fried products containing a large amount of vegetables, such as Satsuma-age containing a large amount of vegetables.

### (Satsuma-Age)

As used herein, “Satsuma-age” refers to a food product made by molding the paste of fish meat and frying it in oil. Satsuma-age is one of fish meat paste products and is classified as fried steamed-fish-paste cake.

### (Vegetables)

In the production of the fish meat paste products (e.g., Satsuma-age) according to the present invention, the vegetables used in exchange for water (or in exchange for part of water in order to reduce the amount of water added) are selected, without particular limitation, from the group consisting of, for example, bean sprouts, Japanese radishes, onions, cabbage, bell peppers, carrots, lettuce, long onions, Chinese cabbage, tomatoes, cucumbers, and a combination thereof.

As used herein, “vegetable mixture” refers to a mixture of two or more kinds of vegetables. The vegetables used in the present invention preferably include, but are not limited to, cut vegetables, mashed vegetables, vegetables crushed with a blender, homogenized vegetables, enzyme-treated vegetables, and fermented vegetables. In addition, in the case of vegetables having a relatively strong protease activity such as onions, it is preferable to heat-treat them in consideration of the mouth feel of the final product.

The vegetables used in the present invention are preferably cut vegetables. The cut size of the vegetables used in the present invention is preferably but without limitation, for example, 2 cm square for cabbage, 3 cm shreds for carrots and burdocks, and finely chopped size for onions. If necessary, ingredients other than vegetables, such as fish and shellfish raw materials (squid, octopus, shrimp, Hijiki seaweed, etc.) can also be used.

### (Fish Meat Paste)

As to the fish meat paste as used herein, those broadly used for raw ingredients of fishery paste products are suitable. For example, commercially available meat paste can be used for the fish meat paste, and one type of or two or more types of meat paste made with a usual manner, including croaker, walleye pollack, lizardfish, horse mackerel, mackerel, sardine, flatfish, golden threadfin bream, alfonsin, Atka mackerel, codfish, merluza and the like, can be used. Preferably, it is preferable to use 50% or more of the paste of walleye pollack. The fish meat paste includes: rough meat paste obtained by separating flesh portion from a fish body, crushing the flesh portion, dispersing the crushed flesh portion into water and removing water-soluble protein; salt-rubbed meat paste obtained by adding salt to the rough meat paste and further mashing it; frozen meat paste obtained by freezing such meat paste, and the like.

### (Salt)

When salt is used in the present invention, the amount to be added is appropriately selected according to the desired salty taste.

### (Seasoning)

The seasoning used in the present invention is selected, without particular limitation, from the group consisting of, for example, pepper, sugar, monosodium glutamate, and a combination thereof.

### (Comprising No Water)

As used herein, the term, “comprises no water”, means that no water or aqueous solution (e.g., aqueous solution of salt) is added during the preparation of a mixture including fish meat paste, salt, seasonings, starch and vegetables, in the production of Satsuma-age. Alternatively, the term means that no water or aqueous solution (e.g., aqueous solution of salt) is added during the preparation of a mixture of soft flour, vegetables and eggs, in the production of batter liquid.

### (Production of Satsuma-Age)

As used herein, the term, “Satsuma-age”, is used interchangeably with the term, “fried steamed-fish-paste cake”.

The Satsuma-age according to the present invention can be produced by a method comprising:

(a) a step of providing a mixture that includes fish meat paste, salt, seasoning, starch and a vegetable, wherein the amount of the vegetable in the mixture is 50% by weight or more;
(b) a step of molding the mixture in the step (a) into a certain shape; and
(c) a step of cooking the mixture molded in the step (b) with oil. Preferably, no water or aqueous solution is added in the step (a). In the prior art, Satsuma-age is produced by adding auxiliary raw materials, such as salt, seasonings and starch, and water to fish meat paste, followed by mixing and molding, and then cooking with oil. According to the present invention, by using no water (or by reducing the amount of water to be added to 30% or less, 20% or less, 10% or less, 7% or less, 5% or less, 3% or less, 2% or less, 1% or less, or 0.5% or less of the original amount to be added) and instead by adding vegetables, it has become possible to produce Satsuma-age containing a large amount of vegetables, as compared with the conventional methods. Although not wishing to be bound by any theory, it is conceivable that the excellent effects of the present invention are exerted by using the water content of vegetables in exchange for the water content added as water.

In the conventional methods, a relatively large amount of water is used. Thus, when vegetables are added in an amount of 50% by weight or more, problems such as deterioration of mouth feel, deterioration of deliciousness and/or difficulty in processing occur. Because of this, it has been difficult in reality for the amount of vegetables added to exceed 50% by weight, in the production of Satsuma-age by the conventional methods.

The content of vegetables in the mixture in the above step (a) is 50% by weight or more, 55% by weight or more, 60% by weight or more, 65% by weight or more, 70% by weight or more, or 75% by weight or more and is 80% by weight or less, 75% by weight or less, or 70% by weight or less.

Alternatively, it is preferable to substitute vegetables for 100%, 95%, 90%, 80% or 70% of the water (aqueous solution) (all on a weight basis) added in the conventional methods during the production of the mixture in the above step (a).

For the molding in the above step (b) and the cooking with oil in the above step (c), it is possible to use such conditions that are customarily used during the production of Satsuma-age.

According to the present invention, by using no water (or by reducing the amount of water to be added to 30% or less, 20% or less, 10% or less, 7% or less, 5% or less, 3% or less, 2% or less, 1% or less, or 0.5% or less of the original amount to be added) as described above, it has become possible to produce Satsuma-age excellent in mouth feel and flavor more than expected. The present invention also exerts an excellent effect of increasing the content of the dietary fiber, mineral components such as calcium, iron and potassium, and vitamins contained in vegetables.

### (Batter Liquid)

The present inventors produced excellent Satsuma-age by adding a large amount of vegetables instead of adding water (aqueous solution) during the preparation of a mixture of fish meat paste, salt, seasonings and starch, in the production of the Satsuma-age. On the basis of this idea, the present inventors expected that they would also be able to produce fried products excellent in mouth feel and flavor, specifically by using no water in or by reducing the amount of water added to the batter liquid, in the production of fried products other than Satsuma-age, thereby completing the batter liquid according to the present invention.

According to the present invention, by using no water or reducing the amount of water to be added as described above, it has become possible to produce batter liquid excellent in mouth feel and flavor more than expected. The present invention also exerts an excellent effect of increasing the content of the dietary fiber, mineral components such as calcium, iron and potassium, and vitamins contained in vegetables. Although not wishing to be bound by any theory, it is conceivable that the excellent effects of the present invention are exerted by using the water content of vegetables in exchange for the water content added as water.

The vegetable content in the batter liquid according to the present invention is most preferably the same as the content of the water, that is to say, it is most preferable to substitute vegetables for the total amount of water. Alternatively, it is preferable to substitute vegetables for 70% to 100% (all on a weight basis) of the water (aqueous solution) to be added during the production of regular batter liquid.

### EXAMPLES

Hereinafter, the present invention will be described in more detail with the Examples. Note that the present invention is not limited to the Examples.

### (Methods for Producing Fish Meat Paste Products in General)

Fish meat paste products, such as tube-shaped fish paste cake (Chikuwa), bamboo-leaf-shaped fish cake (Sasakamaboko), fish cake with a spiral whirlpool-like pattern (Narutomaki) and steamed fish cake served on a board (Mushikamaboko), are prepared by adding salt to fish meat paste, mashing the fish meat paste, and then adding thereto a certain amount of water together with various auxiliary raw materials. Hereinafter, methods for producing such fish meat paste products will be each exemplified.

### (1. Tube-Shaped Fish Paste Cake, Chikuwa)

A typical method for producing the tube-shaped fish paste cake is as follows:

crushing fish meat paste→mashing (salt rubbing→mixing with auxiliary raw materials such as starch and seasonings→adding water)→molding (winding around a spit)→roasting→pulling out the spit→cooling→packaging.

### (2. Bamboo-Leaf-Shaped Fish Cake, Sasakamaboko)

A typical method for producing the bamboo-leaf-shaped fish cake is as follows:

crushing fish meat paste→mashing (salt rubbing→mixing with auxiliary raw materials such as starch and seasonings→adding water)→molding (skewering)→roasting→pulling out the skewer→cooling→packaging.
(3. Fish Cake with a Spiral Whirlpool-Like Pattern, Narutomaki)

A typical method for producing the fish cake with a spiral whirlpool-like pattern is as follows:

crushing fish meat paste→mashing (salt rubbing→mixing with auxiliary raw materials such as starch and seasonings→adding water)→whirlpool-like pattern molding and cutting→preheating→wave-like molding and steaming→dipping→allowing to cool→vacuum packaging secondary sterilization→cooling.

### (4. Steamed Fish Cake Served on a Board, Mushikamaboko)

A typical method for producing the steamed fish cake served on a board is as follows:

crushing fish meat paste→mashing (salt rubbing→mixing with auxiliary raw materials such as starch and seasonings→adding water)→molding (placing on a board)→allowing to sit→heating→cooling→packaging.

In the production method according to the present invention, one of the features is to use fresh vegetables in exchange for water (e.g., in exchange for the whole water or in exchange for 70% or more of the water), for the above-exemplified, typical paste products (such as tube-shaped fish paste cake, bamboo-leaf-shaped fish cake, fish cake with a spiral whirlpool-like pattern and steamed fish cake served on a board). Hereinafter, the present invention will be described with Satsuma-age used as an example. However, the present invention is not an invention that is limited to Satsuma-age, and the present invention is applicable to the above-described typical fish meat paste products as well as to other fish meat paste products obvious to those skilled in the art.

### (1) Production of Satsuma-Age (Fried Steamed-Fish-Paste Cake)

### Example 1: Prior Art

Meat paste for fried steamed-fish-paste cake was made using a conventional method, by adding 1.2% auxiliary raw materials, such as salt, seasonings and starch, and 45.3% water to 36% frozen walleye pollack paste. Next, a 46% mixture of cut-processed vegetables was added and mixed with the 54% meat paste, followed by molding into a certain shape, and cooking with oil using a conventional method, thereby producing fried steamed-fish-paste cake with vegetables.

### Example 2

In exchange for the 45.3% water of Example 1, the same amount of mashed Japanese radish was added, and the same method as in Example 1 was used for the rest, thereby producing fried steamed-fish-paste cake with vegetables.

### Example 3

Bean sprouts were used in exchange for the water of Example 1, with the rest conducted the same as Example 1, thereby producing fried steamed-fish-paste cake with vegetables.

### Example 4

Onions were used in exchange for the water of Example 1, with the rest conducted the same as Example 1, thereby producing fried steamed-fish-paste cake with vegetables.

### Example 5

An equal mixture of Japanese radish and bean sprouts was used in exchange for the water of Example 1, with the rest conducted the same as Example 1, thereby producing fried steamed-fish-paste cake with vegetables.

### Example 6

Next, sensory evaluation was conducted, with fifteen individuals, on the mouth feel, flavor and the like of the products of Example 2 (with Japanese radish), Example 3 (with bean sprouts), Example 4 (with onions) and Example 5 (with an equal mixture of Japanese radish and bean sprouts), with the product made in Example 1 used as a control. The results are shown in Table 1 below.

TABLE 1
Evaluation results of fried steamed-fish-paste
cake with vegetables

| | | 1 (control) | 2 | 3 | 4 | 5 |
|---|---|---|---|---|---|---|
| Mouth | slightly hard | 0 | 0 | 0 | 0 | 0 |
| Feel | same | 15 | 15 | 12 | 11 | 13 |
| | slightly soft | 0 | 0 | 3 | 4 | 2 |
| Flavor | good | 0 | 15 | 1 | 14 | 15 |
| | same | 15 | 0 | 13 | 0 | 0 |
| | slightly poor | 0 | 0 | 1 | 1 | 0 |

### Example 7

Further, 54% of each of the paste meat prepared by changing the added water ratio from 45.3% to 54.3% and the paste meat prepared by changing the added water ratio to 63.8% in Example 1 (prior art) was used, and 46% of a mixture of cut-processed vegetables was added and mixed therewith, using a conventional method, thereby producing fried steamed-fish-paste cake with vegetables. Then, sensory evaluation was conducted, with fifteen individuals, on the mouth feel and flavor, with the fried steamed-fish-paste cake with vegetables prepared with the paste meat with the added water ratio of 45.3% used as a control (Example 1, 70% vegetable ratio), the product with the paste meat with the added water ratio of 54.3% (75% vegetable ratio), and the product with the paste meat with the added water ratio of 63.8% (80% vegetable ratio). The evaluation results are shown in Table 2 below.

TABLE 2
Evaluation results of products with different ratios
of vegetables used

| | | 70% (control | | |
|---|---|---|---|---|
| | | product) | 75% | 80% |
| Mouth | slightly hard | 0 | 0 | 0 |
| Feel | same | 15 | 15 | 5 |
| | slightly soft | 0 | 0 | 10 |
| Flavor | good | 15 | 15 | 2 |
| | same | 0 | 0 | 3 |
| | slightly poor | 0 | 0 | 10 |

In view of the above results, when the ratio of vegetables used was around 80%, the mouth feel and flavor tended to deteriorate, and it was considered that the optimum ratio of vegetables used was around 75%.

### (2) Method for Preparing Batter Liquid

### Example 8: Evaluation of Fried Products Made with Batter Liquid Prepared by Using a Fresh Vegetable (Japanese Radish) in Exchange for Water

### (Preparation of Batter Liquid)

Soft flour, water and eggs chilled in the refrigerator were used, and the mixture thereof at the ratio shown in Table 3 was used as batter liquid (control plot). For the test plot, a homogenized version of Japanese radish chilled in the refrigerator was used in exchange for water. As for the rest, those prepared the same as in the control plot was used. The preparation thereof is shown in Table 3 below.

TABLE 3
Preparation of batter liquid

| | control plot | test plot |
|---|---|---|
| soft flour | 140 g | 140 g |
| water | 200 g | — |
| Japanese radish (homogenized) | — | 200 g |
| egg | 60 g | 60 g |

### (Preparation of Fried Ingredients)

For fried ingredients, fried, tube-shaped fish paste cake was used, which was cut in half lengthwise into the length of 5 cm. Also used were sweet potatoes, which were washed, cut into round slices, put in water and drained, and prawns (black tiger prawns) with their shell and digestive tract removed and processed so as not to bend, and these ingredients were fried in tempura oil using a conventional method. Then, sensory evaluation was conducted, with fifteen individuals, on the flavor and taste with regard to each of the fried food. The results are shown in Table 4 below.

TABLE 4
Evaluation results of respective fried products

| | | tube shaped | | | | | |
|---|---|---|---|---|---|---|---|
| | | fish paste cake | | sweet potato | | prawn | |
| | | control plot | test plot | control plot | test plot | control plot | test plot |
| flavor | good | 0 | 12 | 0 | 9 | 0 | 14 |
| | same | 15 | 3 | 15 | 6 | 15 | 1 |
| | slightly poor | 0 | 0 | 0 | 0 | 0 | 0 |
| taste | good | 0 | 13 | 0 | 9 | 0 | 15 |
| | same | 15 | 2 | 15 | 6 | 15 | 0 |
| | slightly poor | 0 | 0 | 0 | 0 | 0 | 0 |

As shown above, the batter liquid according to the present invention was excellent in flavor and taste.

In making fried products such as tube-shaped fish paste cake, prawn, vegetables and the like, those made with the batter liquid prepared with a fresh vegetable (Japanese radish) in exchange for water were more delicious than those made with batter liquid prepared with water.

Based on the above, the present production method can be used in the preparation of batter liquid to be used in making fried products, in exchange for water. According to the present production method, fresh vegetables can be used in exchange for water in the preparation of typical paste products and batter liquid.

The present invention has been exemplified above using preferred embodiments of the invention, but the present invention should not be interpreted to be limited to the embodiments. It is also understood that the scope of the present invention should be interpreted solely from the scope of Claims. It is understood that those skilled in the art can implement an equivalent scope from the descriptions of the specific preferred embodiments of the invention based on the description of the present invention and common general knowledge. It is understood that any patent, any patent application, and any references cited herein should be incorporated herein by reference in the same manner as the contents are specifically described herein.

### INDUSTRIAL APPLICABILITY

With regard to fried products such as Satsuma-age, the present invention allows providing of such products with increased vegetable content. In addition, the present invention provides batter liquid containing vegetables. The food products provided by the present invention are rich in vegetable-derived nutrients and excellent in flavor, taste, and mouth feel.

1. A fish meat paste product comprising 50% by weight or more of a vegetable.

2. Satsuma-age comprising a vegetable, wherein the amount of the vegetable in the Satsuma-age is 50% by weight or more.

3. The Satsuma-age of claim 2, wherein the amount of the vegetable in the Satsuma-age is 60% by weight or more.

4. The Satsuma-age of claim 2, wherein the amount of the vegetable in the Satsuma-age is 60 to 80% by weight.

5. The Satsuma-age of claim 2, wherein the vegetable is a cut-processed vegetable or a mashed vegetable and wherein the vegetable is selected from the group consisting of a vegetable mixture, a bean sprout, a Japanese radish, an onion and a combination thereof.

6. A producing method of Satsuma-age, the method comprising:
(a) a step of providing a mixture that includes fish meat paste, salt, seasoning, starch and a vegetable, wherein the amount of the vegetable in the mixture is 50% by weight or more;
(b) a step of molding the mixture in the step (a) into a certain shape; and
(c) a step of cooking the mixture molded in the step (b) with oil.

7. The producing method of claim 6, wherein no water is added to the mixture in the step (a).

8. The producing method of claim 6, wherein the amount of the vegetable in the mixture of the step (a) is 60% by weight or more.

9. The producing method of claim 6, wherein the amount of the vegetable in the mixture of the step (a) is 60 to 80% by weight.

10. The producing method of claim 6, wherein the vegetable is a cut-processed vegetable or a mashed vegetable and wherein the vegetable is selected from the group consisting of a vegetable mixture, a bean sprout, a Japanese radish, an onion and a combination thereof.

11. Satsuma-age produced by the producing method of claim 6.

12. Batter liquid comprising soft flour, a vegetable and egg, wherein the content of the vegetable is 50% by weight or more.

13. The batter liquid of claim 12 which comprises no water.

14. The batter liquid of claim 12 which consists of soft flour, a vegetable and egg.

15. A producing method of batter liquid, the method comprising a step of preparing a mixture that includes soft flour, a vegetable and egg, characterized in that no water is added to the mixture.

16. A fried product made with the batter liquid of claim 12.

17. A fried product made with the batter liquid produced by the producing method of claim 15.
